(19) United States
(12) Patent Application Publication
(10) Pub. No.: US 2011/0090569 A1
(43) Pub. Date: Apr. 21, 2011

(54) OPTICAL COMPONENT HAVING ANTIREFLECTION STRUCTURE AND METHOD OF MANUFACTURING OPTICAL COMPONENT

(76) Inventor: Yoshiyuki Furuyama, Miyagi-Ken (JP)

(21) Appl. No.: 12/972,076

(22) Filed: Dec. 17, 2010

Related U.S. Application Data
(63) Continuation of application No. PCT/JP2009/061441, filed on Jun. 24, 2009.

(30) Foreign Application Priority Data
Jul. 4, 2008 (JP) 2008-176135

(51) Int. Cl. G02B 5/00; B29D 11/00

(52) U.S. Cl. 359/601; 264/2.5

(57) ABSTRACT

There is provided an optical component in which an antireflection structure is formed on a light incident surface or a light outgoing surface. The surface of the antireflection structure is divided into a plurality of areas, a plurality of protruded portions and a plurality of groove portions that linearly extend to be parallel to one another are formed on each of the areas by being alternately repeated, and in the areas that are adjacent to each other, the directions in which the protruded portions and the groove portions extend are different from each other by 90 degrees.

### CLAIM OF PRIORITY

This application is a Continuation of International Application No. PCT/JP2009/061441 filed on Jun. 24, 2009, which claims benefit of Japanese Patent Application No. 2008-176135 filed on Jul. 4, 2008. The entire contents of each application noted above are hereby incorporated by reference.

### BACKGROUND OF INVENTION

1. Field of the Invention

The present invention relates to an optical component such as a lens or a diffraction grating, and more particularly, to an optical component having a fine concave-convex shaped antireflection structure formed on the light incident surface thereof and a method of manufacturing the optical component.

2. Description of the Related Art

Various optical components such as lenses or diffraction gratings have antireflection structures arranged on the light incident surfaces. As examples of the antireflection structure, there are a structure formed by stacking a plurality of thin films having different refractive indices on the incident surface and a structure in which fine prominences and depressions are formed on the incident surface as disclosed in Japanese Unexamined Patent Application Publication No. 2003-222701, Japanese Unexamined Patent Application Publication No. 2005-181740, and Japanese Unexamined Patent Application Publication No. 2006-039450.

The above-described structure in which fine prominences and depressions are formed as the antireflection structure has advantages over the structure formed by stacking a plurality of thin films that the wavelength band of light that can be prevented from being reflected can be formed to be broad and light transmittance is high.

### SUMMARY OF THE INVENTION

### Brief Description of the Drawings

According to a method of manufacturing an antireflection structure having a fine concave-convex pattern on the incident surface of the optical component, a resist layer is formed on the surface of a mold, and the resist layer is partially exposed so as to be developed in accordance with the concave-convex pattern, so that a part of the resist layer remains. Then, the incident surface of the optical component is etched or milled in a portion in which the resist layer is eliminated, and thereby a transfer pattern having fine prominences and depressions on the surface of the mold is formed. When the optical component is formed by using the mold, the transfer pattern is transferred to the incident surface of the optical component, and thereby the antireflection structure is formed.

Since the pitch of the prominences and the depressions of the antireflection structure is fine, commonly, exposure is performed by scanning the surface of the resist layer using electron beams. In such a case, since the area of the range in which exposure can be performed using the electron beams is limited, it is necessary that the surface of the resist layer is divided into a plurality of areas, and the resist layer is exposed by scanning each area using the electron beams.

However, when the scanning range of the electron beams is changed from an area for which scanning is completed to an adjacent area, occurrence of an error in the relative transmission distance between the electron beam emitting unit and the mold cannot be avoided. Exposure areas between areas adjacent to each other overlap with each other due to the error, and a defective portion of the resist layer may be easily formed in the boundary portion of the areas adjacent to each other. When the defective portion is formed in the boundary portion of the areas, a problem of decreasing reflectance of light on the incident surface and the like may easily occur.

An advantage of some aspects of the invention is to provide an optical component capable of consistently maintaining high reflectance of light on the incident surface by preventing formation of a defective portion or the like in the boundary portion of a plurality of divided areas when the antireflection structure is formed on the light incident surface and a method of manufacturing the optical component.

According to an embodiment of the present invention, there is provided an optical component in which an antireflection structure is formed on a light incident surface or a light outgoing surface. The surface of the antireflection structure is divided into a plurality of areas, a plurality of protruded portions and a plurality of groove portions that linearly extend to be parallel to one another are formed on each of the areas by being alternately repeated, and in the areas that are adjacent to each other, the directions in which the protruded portions and the groove portions extend are different from each other by 90 degrees.

In the above-described optical component, the antireflection structure may include a portion in which the protruded portions extending in the directions different from each other by 90 degrees are connected together in a boundary portion of the areas that are adjacent to each other and a portion in which the groove portions extending in the directions different from each other by 90 degrees are connected together in the boundary portion of the areas that are adjacent to each other.

For example, each of the areas is a quadrilateral.

According to another embodiment of the present invention, there is provided a method of manufacturing an optical component including the steps of: forming a concave-convex transfer pattern on a surface of a mold; and forming an antireflection structure of a concave-convex shape by transferring the transfer pattern to a light incident surface of the optical component when the optical component is formed by using the mold. The antireflection structure to which the transfer pattern is transferred is divided into a plurality of areas, a plurality of protruded portions and a plurality of groove portions that linearly extend to be parallel to one another are formed on each of the areas by being alternately repeated, and in the areas that are adjacent to each other, the directions in which the protruded portions and the groove portions extend are different from each other by 90 degrees.

In the above-described method of manufacturing an optical component, the transfer pattern may be formed by forming a resist layer on a surface of the mold, allowing a part of the resist layer to remain by exposing the resist layer using electron beams so as to be developed, and eliminating the surface of the mold in a portion in which the resist layer does not exist.

For example, in the above-described method of manufacturing an optical component, the resist layer is exposed in units of areas by emitting the electron beams to the resist layer in units of the areas.

In the above-described method of manufacturing an optical component, the optical component may be formed by pressing an optical material using the mold, or the optical component may be formed by supplying a melted optical material to the inside of the mold and cooling the optical material.

According to an optical component according of an embodiment of the present invention, a light incident surface of a light outgoing surface is divided into a plurality of quadrilaterals, and more preferably, into a plurality of squares, protruded portions and groove portions are linearly formed to be parallel to each other in each area, and the directions of the protruded portions and the groove portions are orthogonal to each other in the adjacent areas. Accordingly, even when a slight error in the arrangement pitch of the areas occurs, formation of a defective portion having a large width in the boundary portion of the adjacent areas and the like can be prevented.

In addition, according to an optical component of an embodiment of the present invention, the directions of the protruded portions and the groove portions of the areas adjacent to each other are different by 90 degrees. Accordingly, a stable antireflection effect can be consistently exhibited regardless of the polarization direction of light that is incident to the incident surface or outgoing from the outgoing surface. In addition, since a large defective portion or the like cannot be formed on the boundary face of the areas adjacent to each other, a decrease in the antireflection efficiency due to a defective arrangement pitch of the areas can be suppressed.

In addition, according to a method of manufacturing an optical component of an embodiment of the present invention, the protruded portions and the groove portions having a fine pitch can be formed with high precision by using electron beams. Furthermore, an optical component capable of suppressing a decrease in the antireflection efficiency of the incident surface or the outgoing surface even in a case where there is a defect in the pitch of the areas can be manufactured.

### BRIEF DESCRIPTION OF THE DRAWINGS

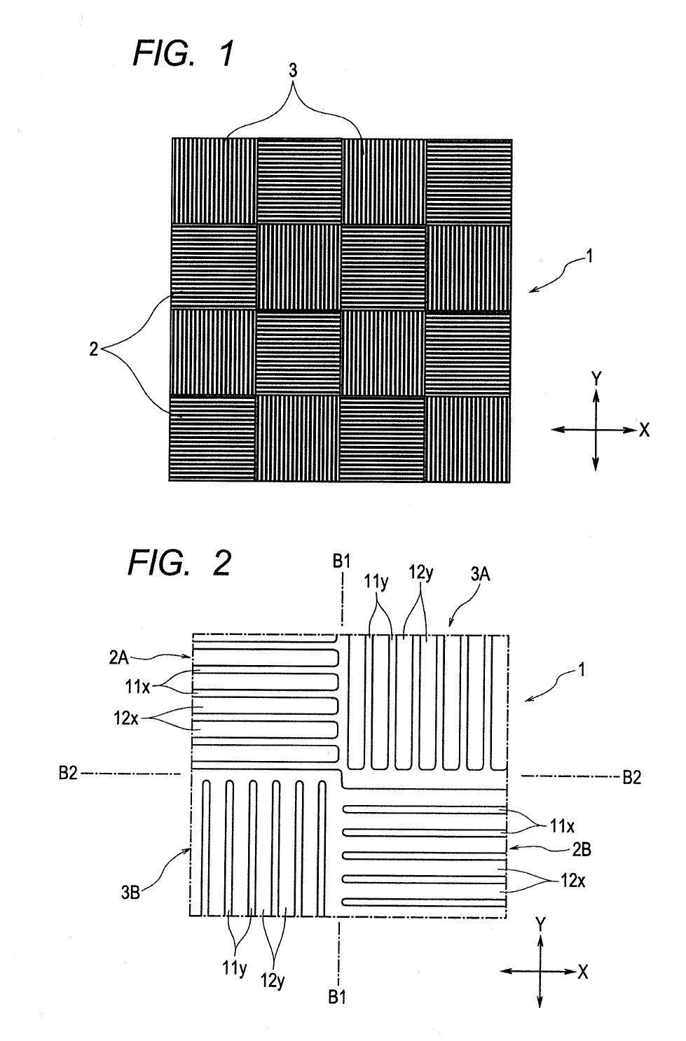

FIG. 1 is a plan view showing a part of an antireflection structure formed in an optical component according to an embodiment of the present invention.

FIG. 2 is an enlarged plan view of the antireflection structure shown in FIG. 1.

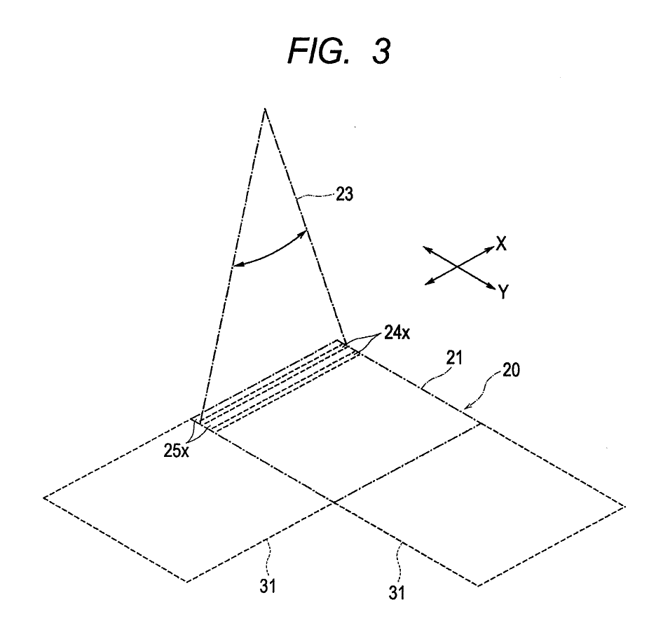

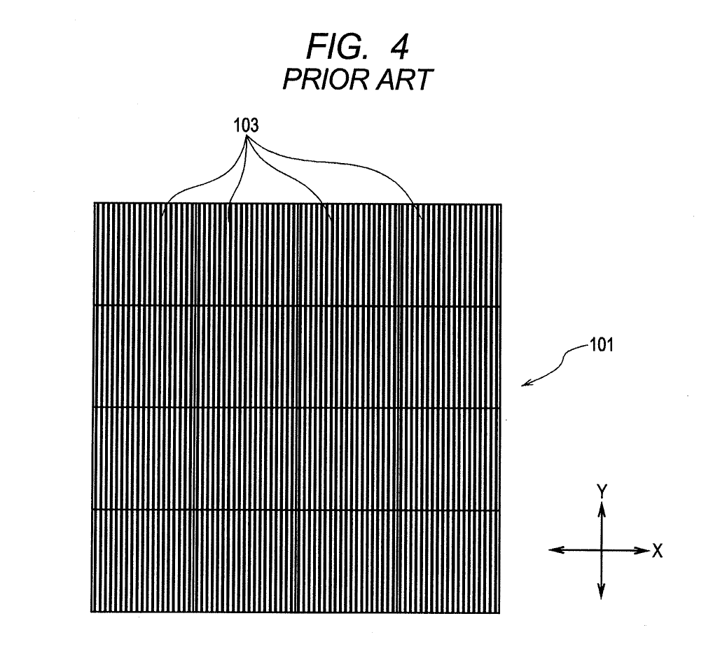

FIG. 3 is a schematic diagram illustrating a process of exposing a resist layer using an electron beam in a manufacturing process of the antireflection structure.

FIG. 4 is a plan view showing an antireflection structure of an optical component of a comparative example.

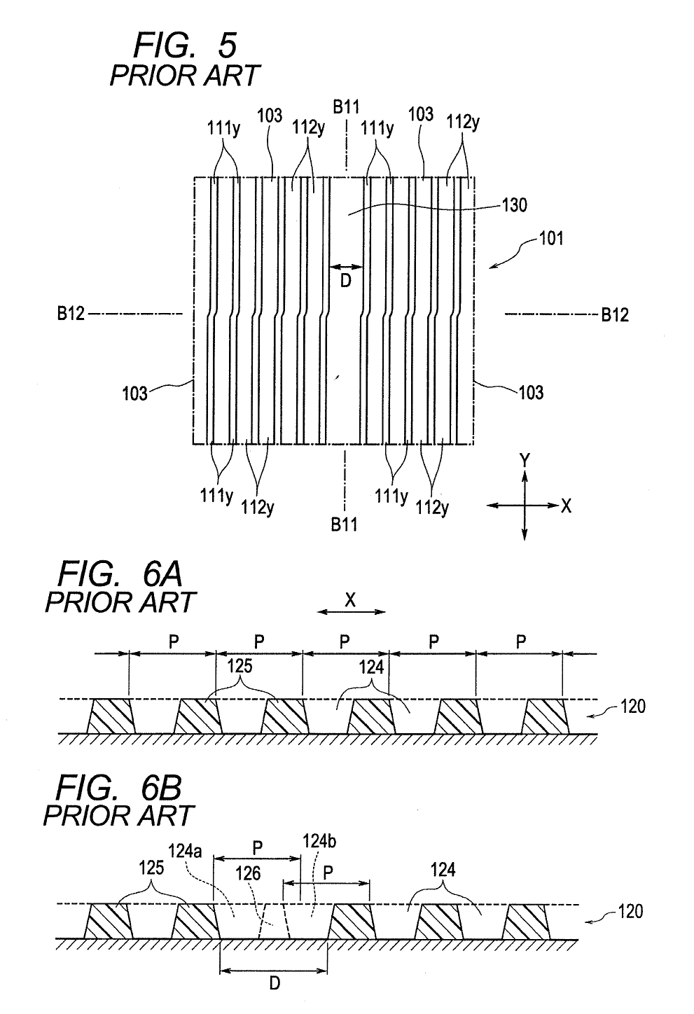

FIG. 5 is an enlarged plan view of the comparative example shown in FIG. 4.

FIGS. 6A and 6B are enlarged cross-sectional views showing the state in which a resist layer is exposed and developed in a manufacturing process of an antireflection structure of the comparative example. FIG. 6A shows a state in which the area arrangement pitch of partition areas to be exposed is normal, and FIG. 6B shows a state in which the area arrangement pitch of the partition areas is defective.

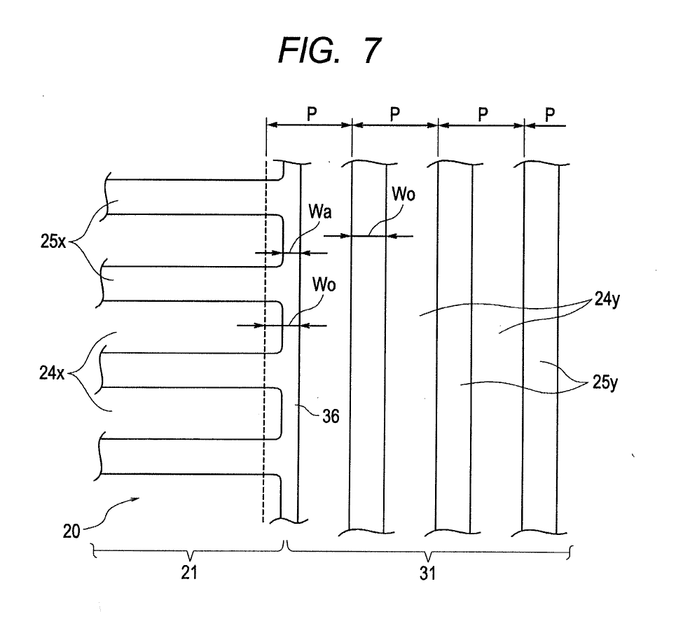

FIG. 7 is a plan view showing a state in which a resist layer is exposed and developed in a manufacturing process of an antireflection structure according to an embodiment of the present invention, and shows a state in which the area arrangement pitch of the partition areas to be exposed is defective.

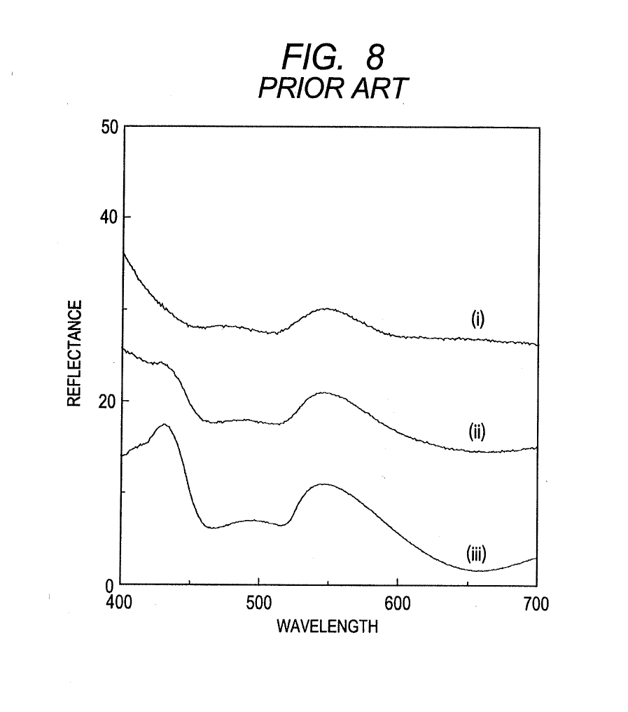

FIG. 8 is a line diagram showing a measurement result of reflectance of the antireflection structure of the comparative example.

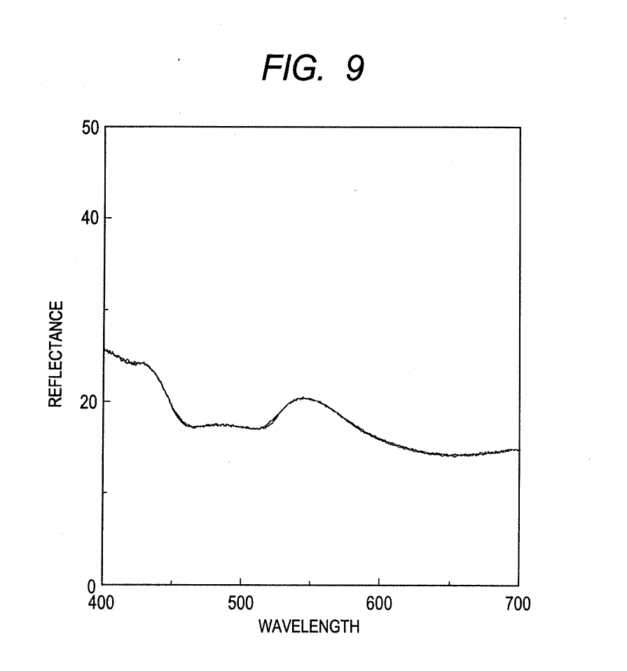

FIG. 9 is a line diagram showing a measurement result of reflectance of the antireflection structure according to an embodiment of the present invention.

### DESCRIPTION OF THE PREFERRED EMBODIMENTS

FIG. 1 is a plan view showing a part of an antireflection structure formed in an optical component according to an embodiment of the present invention. FIG. 2 is an enlarged plan view of the antireflection structure shown in FIG. 1. FIG. 3 is a schematic diagram illustrating a process of exposing a resist layer using an electron beam. FIG. 4 is a plan view showing an antireflection structure of an optical component of a comparative example. FIG. 5 is an enlarged plan view of the comparative example shown in FIG. 4. FIGS. 6A and 6B are schematic diagrams illustrating problems of the above-described comparative example. FIG. 7 is a schematic diagram illustrating advantages of an embodiment of the present invention. FIG. 8 is a line diagram showing a measurement result of the reflection prevention rate of the antireflection structure of the above-described comparative example. FIG. 9 is a line diagram showing a measurement result of the reflection prevention rate of an antireflection structure according to an embodiment of the present invention.

The antireflection structure 1 shown in FIGS. 1 and 2 is formed on a light incident face or a light outgoing face of the optical component. The optical component is a lens, a diffraction grating, a prism, a beam splitter, a transparent cover that is arranged in a light passing area of a case housing a light emitting element or a light receiving element, or the like. Any of the above-described optical components is formed from a substantially transparent optical material having high light transmittance.

For example, the optical component is formed by pressing heated glass with a mold. In such a case, a transfer pattern having fine prominences and depressions formed on the surface of the mold is transferred to the incident surface or the outgoing surface of the optical component, and thereby the above-described antireflection structure 1 is formed. Alternatively, the optical component may be formed by injecting an organic optical material into the inside of a melted mold. In such a case, a transfer pattern having fine prominences and depressions formed on the surface of the mold is transferred to the incident surface or the outgoing surface of the optical component, and thereby the above-described antireflection structure 1 is formed.

As shown in FIG. 1, in the antireflection structure 1, a first area 2 having protruded portions and groove portions that extend parallel to the X direction and a second area 3 having protruded portions and groove portions that extend parallel to the Y direction are alternately arranged in both the X direction and the Y direction. The first area 2 and the second area 3 are quadrilaterals and are preferably squares.

In FIG. 2, the structure and the arrangement state of two of the first areas 2A and 2B and two of the second areas 3A and 3B that are adjacent thereto are shown in an enlarged scale. In FIG. 2, a boundary line on the design that is a boundary between the first area 2A and the second area 3A and a boundary between the first area 2B and the second area 3B and extends in the Y direction is denoted by B1. In addition, a boundary line on the design that is a boundary between the first area 2A and the second area 3B and a boundary between the first area 2B and the second area 3A and extends in the X direction is denoted by B2.

As shown in FIG. 2, in the first areas 2A and 2B, a plurality of protruded portions 11x and a plurality of groove portions 12x linearly extend in the X direction. The protruded portions 11x and the groove portions 12x are alternately disposed in the Y direction, the plurality of the protruded portions 11x is parallel to one another, the plurality of the groove portions 12x is parallel to one another, and the protruded portions 11x and the groove portions 12x are parallel to one another. In the second areas 3A and 3B, a plurality of protruded portions 11y and a plurality of groove portions 12y linearly extend in the Y direction. The protruded portions 11y and the groove portions 12y are alternately disposed in the X direction. The plurality of the protruded portions 11y is parallel to one another, the plurality of the groove portions 12y is parallel to one another, and the protruded portions 11y and the groove portions 12y are parallel to one another.

Both the width dimension of the protruded portions 11x and 11y and the width dimension of the groove portions 12x and 12y are in the range of about 100 nm to 500 nm. In addition, the depth dimension of the groove portions 12x and 12y and the width dimension of the protruded portions 11x and 11y are in the range of the same degree. The length dimension of one side of the first areas 2A and 2B is in the range of about 200 to 400 μm.

Next, a method of forming the above-described antireflection structure 1 in the optical component will be described.

Among molds that form the optical component, on the surface of a mold that transfers the incident surface or the outgoing surface, a resist layer is formed, and the resist layer is partially exposed by using an electron beam exposure device. FIG. 3 illustrates a process of exposing a band-shaped pattern in a partition area 21 of the resist layer 20 corresponding to the first area 2. From a beam tube of the electron beam exposure device, electron beams 23 are intermittently emitted, and a fine spot is formed on the resist layer 20 so as to be exposed.

As shown in FIG. 3, inside the partition area 21 corresponding to the first area 2, a fine spot is sequentially moved in the X direction and in the Y direction, and band-shaped photosensitive portions 24x are formed by scanning of the electron beams 23. A plurality of the band-shaped photosensitive portions 24x is parallel to one another and linearly extends in the X direction. In addition, between the photosensitive portion 24x and the photosensitive portion 24x, a band-shaped non-photosensitive portion 25x is formed. A plurality of the band-shaped non-photosensitive portion 25x is parallel to one another and linearly extends in the X direction.

As shown in FIG. 3, inside the partition area 21 corresponding to the first area 2, after the photosensitive portions 24x and the non-photosensitive portions 25x are formed, an X-Y table that maintains the mold is moved in the X direction or the Y direction inside the electron beam exposure device, and the radiation area of the electron beams 23 is moved by one area pitch. Then, in a partition area 31 that is adjacent to the partition area 21 for which exposure has been already completed, similarly, a band-shaped pattern corresponding to the second area 3 is exposed. In the adjacent partition area 31, a photosensitive portion and a non-photosensitive portion are formed so as to linearly extend in the Y direction.

After exposure of the partition area 21 corresponding to the first area 2 and the partition area 31 corresponding to the second area 3 is completed in the almost entire area of the surface to which the incident surface of the mold is transferred, the process proceeds to a development process. When the resist layer is for the positive use, the resist layer of the photosensitive portion 24x is eliminated, and the resist layer of the non-photosensitive portion 25x remains. Then, the surface of the mold is etched or milled in the portion in which the resist layer is eliminated so as to eliminate the surface of the mold from the band-shaped area. Thereafter, by eliminating the remaining resist layer, a transfer pattern having fine prominences and depressions is formed on the surface of the mold.

By performing press molding of an optical material or injection molding of an optical material by using the above-described mold, the optical component is formed, and the antireflection structure 1 shown in FIGS. 1 and 2 is transferred to the light incident surface or the light outgoing surface of the optical component so as to be formed.

An antireflection structure 101 of a comparative example shown in FIGS. 4 and 5 is divided into a plurality of areas 103. The area 103 is a quadrilateral and is formed to have the same area as the first area 2 and the second area 3 of the embodiment. The areas 103 are alternately arranged in the X direction and in the Y direction. In FIG. 5, a boundary line extending in the Y direction on the boundary of adjacent areas 103 is denoted by B11, and a boundary line extending in the X direction is denoted by B12.

In the area 103, the protruded portion 111y and the groove portion 112y are alternately formed in the X direction. However, in the comparative example, in all the areas 103, the protruded portion 111y and the groove portion 112y linearly extend in the Y direction and are formed to be parallel to each other.

The antireflection structure of the comparative example is formed by using the same manufacturing method as that of the above-described embodiment. In other words, a resist layer is formed on the surface of the mold, and electron beams are emitted to the partition areas that are divided on the surface of the resist layer, whereby a photosensitive portion and a non-photosensitive portion are formed so as to extend in the Y direction. Then, after the photosensitive portions and the non-photosensitive portions are formed in all the partition areas that are adjacent to each other by moving the X-Y table and additionally performing exposure, the resist layer is developed. Then, fine prominences and depressions are formed on the surface of the mold by an etching or milling process, and by transferring the surface of the mold to the incident surface of the optical component, the antireflection structure 101 shown in FIGS. 4 and 5 is formed. The width dimension and the like of the protruded portion 111y and the groove portion 112y of the antireflection structure of the comparative example are the same as those of the protruded portions 11x and 11y and the groove portions 12x and 12y of the embodiment.

When the antireflection structure 1 of the embodiment of the present invention that is shown in FIG. 2 and the antireflection structure 101 of the comparative example shown in FIG. 5 are compared together, it is difficult to form a defective portion in the boundary portion of the areas, which are adjacent to each other, of the embodiment, compared to the comparative example. In other words, as shown in FIG. 5, in the comparative example, when there is a defect in the inter-area arrangement pitch of the areas 103 and 103 that are adjacent to each other in the X direction, a defective portion 130 having a width dimension D larger than the pitch P of the protruded portions 111y can be easily formed in the portion of the boundary line B11 extending in the Y direction.

FIGS. 6A and 6B are cross-sectional views showing the states in which the resist layer 120 formed on the surface of the mold is exposed so as to be developed. FIGS. 6A and 6B shows the states in which, after a photosensitive portion 124 in which the electron beams 23 are emitted to the resist layer 120 and a non-photosensitive portion 125 in which the electron beams are not emitted are formed, the resist layer of the photosensitive portion 124 is eliminated through development.

FIG. 6A shows a state in which the inter-area arrangement pitch of the partition areas for scanning a fine spot by emitting electron beams thereto is set to a fixed density, and a photosensitive portion 124 and a non-photosensitive portion 125 are formed at a constant pitch P between the areas adjacent to each other. In this case, it is difficult to have a defect of the resist layer formed in the boundary portion of the partition areas adjacent to each other.

However, in a practical sense, generation of a defect in the arrangement pitch of the partition areas adjacent to each other cannot be avoided when the X-Y table is moved, and an adjacent partition area is exposed after completion of exposure of one partition area using electron beams. FIG. 6B shows a state in which an error of about ⅕ of the pitch P of the photosensitive portions 124 occurs in the area arrangement pitch of the partition areas adjacent to each other in the X direction, and both partition areas approach each other. In this case, in the boundary portion of the partition areas adjacent to each other, the photosensitive portion 124a and the photosensitive portion 124b that are adjacent to each other approach each other too closely, and the width dimension of a non-photosensitive portion 126 pinched between the photosensitive portion 124a and the photosensitive portion 124b becomes smaller than the width dimension of a regular non-photosensitive portion 125. As a result, when the resist layer 120 is developed, the non-photosensitive portion 126 having a small width dimension can be easily lost, and whereby there is high possibility that a defective portion having a width dimension D is formed on the resist layer 120.

As shown in FIG. 6B, when the surface of the mold is etched by using the pattern of the resist layer in which a defective portion having the width dimension D is formed, and an optical component is formed by using the mold, as shown in FIG. 5, a defective portion 130 having the width dimension D is formed on the boundary line B11-B11 of the areas 103 adjacent to each other in the antireflection structure 101 that is transferred to the light incident surface. In other words, as the area arrangement pitch of the partition areas formed through exposure using electron beams slightly decreases by ⅕×P, the defective portion 130 that is larger than the pitch P is formed.

FIG. 7 shows a state in which the partition areas adjacent to each other in the X direction approach each other by about ⅕×P as shown in FIGS. 6A and 6B when the resist layer 20 is exposed using electron beams according to an embodiment of the present invention. As shown in FIG. 7, a photosensitive portion 24y and a non-photosensitive portion 25y that extend in the Y direction are formed in the right-side partition area 31, and a photosensitive portion 24x and a non-photosensitive portion 25x that extend in the X direction are formed in the left-side partition area 21. Then, as the partition area 21 and the partition area 31 approach each other by about ⅕×P, the width dimension Wa of the non-photosensitive portion 36 that is located on the leftmost side of the partition area 31 is smaller than the dimension WO of other non-photosensitive portions 25y. However, since the non-photosensitive portion 25x extending in the X direction is continuous in the non-photosensitive portion 36, the non-photosensitive portion 36 having a width dimension Wa is not lost when being developed. Accordingly, a defective portion having the width dimension D shown in FIG. 6B cannot be easily formed.

As a result, as shown in FIG. 2, a defective portion cannot be easily formed in the boundary portion of the areas 2A and 3A, which are adjacent to each other, or the boundary portion of the areas 3B and 2B of the antireflection structure 1 that is formed on the incident surface of the optical component.

For example, as shown in FIG. 2, even in a case where the protruded portion 11x extending in the X direction and the protruded portion 11y extending in the Y direction are connected together on the boundary line B1 of the first area 2A and the second area 3A, a large defective portion cannot be easily formed on the boundary line B1 as on the boundary line B11 shown in FIG. 5. In addition, although the groove portion 12x extending in the X direction and the groove portion 12y extending in the Y direction are connected together so as to communicate with each other on the boundary B1 of the first area 2B and the second area 3B shown in FIG. 2, a large defective portion cannot be easily formed on the boundary line B1 as on the boundary line B11 as shown in FIG. 5.

In other words, in areas adjacent to each other, by mixing a portion in which protruded portions extending in the directions orthogonal to each other are connected and a portion in which groove portions extending in the directions orthogonal to each other, a large defect can be prevented from being formed in the boundary portion of the areas.

FIG. 8 shows a measurement result of reflectance of the antireflection structure 101 formed as the comparative example. FIG. 9 shows a measurement result of reflectance of the antireflection structure 1 of the above-described embodiment.

In both the antireflection structure 1 of the embodiment and the antireflection structure 101 of the comparative example, all the partitions 2, 3, and 103 have a square shape of 300 μm×300 μm. In addition, in both the embodiment and the comparative example, the width dimension of the protruded portion is 300 nm, the width dimension of the bottom of the groove portion is 200 nm, and the depth dimension of the groove portion is 300 nm.

Each antireflection structure was formed on the surface of a Si wafer, ultraviolet rays were vertically emitted to the antireflection structure, and reflectance was measured at a reflection direction of five degrees with respect to the emission direction by using a reflectometer.

In both the embodiment and the comparative example, ultraviolet rays of linearly polarized light were used. The wavelength was in the range of 400 nm to 700 nm. In FIGS. 8 and 9, the horizontal axis is the wavelength of the emitted ultraviolet rays, and the vertical axis is reflectance.

In the comparative example shown in FIG. 8, reflectance in a case where an angle between the polarization direction of the ultraviolet rays and the Y-axis is zero degrees is denoted by “(i)”, reflectance in a case where the above-described angle is 45 degrees is denoted by “(ii)”, and reflectance in a case where the above-described angle is 90 degrees is denoted by “(iii)”. FIG. 9 is a measurement result of the embodiment. In the embodiment, although the ultraviolet rays were emitted while the polarization direction was changed to zero degrees, 45 degrees, and 90 degrees with respect to the Y axis, the reflectance was almost the same.

When the measurement results shown in FIGS. 8 and 9 were compared, it can be understood that the same antireflection effect can be exhibited for any direction of the light polarization according to an embodiment of the present invention. In addition, when the reflectance (ii) at 45 degrees of the comparative example shown in FIG. 8 and the reflectance of the embodiment shown in FIG. 9 are compared, it can be understood that the reflectance according to the embodiment shown in FIG. 9 is slightly higher than that of the comparative example. In other words, according to the comparative example, the defective portion 130 as shown in FIG. 5 is formed due to an error of the arrangement pitch of the areas adjacent to each other, and accordingly, the reflectance slightly decreases for all the wavelengths. However, according to an embodiment of the present invention, the above-described defective portion 130 cannot be easily formed, and as a result, a decrease in the reflectance is suppressed.

It should be understood by those skilled in the art that various modifications, combinations, sub-combinations and alterations may occur depending on design requirements and other factors insofar as they are within the scope of the appended claims of the equivalents thereof.

What is claimed is:

1. An optical component in which an antireflection structure is formed on a light incident surface or a light outgoing surface,
wherein the surface of the antireflection structure is divided into a plurality of areas, a plurality of protruded portions and a plurality of groove portions that linearly extend to be parallel to one another are formed on each of the areas by being alternately repeated, and in the areas that are adjacent to each other, directions in which the protruded portions and the groove portions extend are different from each other by 90 degrees.

2. The optical component according to claim 1, wherein the antireflection structure includes a portion in which the protruded portions extending in the directions different from each other by 90 degrees are connected together in a boundary portion of the areas that are adjacent to each other and a portion in which the groove portions extending in the directions different from each other by 90 degrees are connected together in a boundary portion of the areas that are adjacent to each other.

3. The optical component according to claim 1, wherein the area is a quadrilateral.

4. A method of manufacturing an optical component, the method comprising the steps of:
forming a concave-convex transfer pattern on a surface of a mold; and
forming an antireflection structure of a concave-convex shape by transferring the transfer pattern to a light incident surface of the optical component when the optical component is formed by using the mold,
wherein the antireflection structure to which the transfer pattern is transferred is divided into a plurality of areas, a plurality of protruded portions and a plurality of groove portions that linearly extend to be parallel to one another are formed on each of the areas by being alternately repeated, and in the areas that are adjacent to each other, directions in which the protruded portions and the groove portions extend are different from each other by 90 degrees.

5. The method according to claim 4, wherein the antireflection structure includes a portion in which the protruded portions extending in the directions different from each other by 90 degrees are connected together in a boundary portion of the areas that are adjacent to each other and a portion in which the groove portions extending in the directions different from each other by 90 degrees are connected together in a boundary portion of the areas that are adjacent to each other.

6. The method according to claim 4, wherein the transfer pattern is formed by forming a resist layer on a surface of the mold, allowing a part of the resist layer to remain by exposing the resist layer using electron beams so as to be developed, and eliminating the surface of the mold in a portion in which the resist layer does not exist.

7. The method according to claim 6, wherein the resist layer is exposed in units of areas by emitting the electron beams to the resist layer in units of the areas.

8. The method according to claim 4, wherein the optical component is formed by pressing an optical material using the mold.

9. The method according to claim 4, wherein the optical component is formed by supplying a melted optical material to the inside of the mold and cooling the optical material.
